(19) United States
(12) Patent Application Publication
(10) Pub. No.: US 2010/0112971 A1
(43) Pub. Date: May 6, 2010

(54) FREQUENCY CONVERTING CIRCUIT AND RECEIVER

(75) Inventors: Junya Matsuno, Atsugi-shi (JP); Takafumi Yamaji, Yokohama-shi (JP); Tetsuro Itakura, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/503,199

(22) Filed: Jul. 15, 2009

(30) Foreign Application Priority Data
Oct. 31, 2008 (JP) 2008-282287

(51) Int. Cl. H04B 1/16; H04B 15/00

(52) U.S. Cl. 455/313; 455/334

(57) ABSTRACT

A receiver includes a multiphase mixer that multiplies a received radio signal by multiphase local signals the number of which is the same as an integer having a first prime factor and a second prime factor different from the first prime factor, and generates first multiphase baseband signals the number of which is the same as the integer, a first processing circuit that suppresses common modes for first multiphase signal groups formed by dividing the first multiphase baseband signals into groups of signals the number of which is the same as the first prime factor, and generates second multiphase baseband signals, and a second processing circuit that suppresses common modes for second multiphase signal groups formed by dividing the second multiphase baseband signals into groups of signals the number of which is the same as the second prime factor, and generates third multiphase baseband signals.

### CROSS-REFERENCE TO RELATED APPLICATIONS

This application is based upon and claims the benefit of priority from prior Japanese Patent Application No. 2008-282287, filed Oct. 31, 2008, the entire contents of which are incorporated herein by reference.

### BACKGROUND OF THE INVENTION

1. Field of the Invention

The present invention relates to a frequency converting circuit and a receiver for radio signal reception.

2. Description of the Related Art

In a wireless receiver, a frequency converting circuit performs a down-converting process to generate a baseband signal by multiplying a radio signal received by way of an antenna by a certain local signal. Generally, a pulse wave having a predetermined fundamental frequency is adopted for this local signal. The local signal includes the fundamental frequency component and also harmonic components, which are signal components having frequencies that are integral multiples of the fundamental frequency. For this reason, if an interfering wave is received and a difference between frequencies of this interfering wave and the target radio signal is an integral multiple of the fundamental frequency, the interfering wave is also subjected to the down-converting process so that its frequency is converted into the same frequency band as that of the baseband signal (hereinafter, simply referred to as “baseband frequency band”). The baseband signal on which the interfering wave is superimposed degrades the S/N ratio (SNR).

Conventionally, a two-phase mixer (such as a double-balanced mixer or a single-balanced mixer) is utilized as a frequency converting circuit. A two-phase mixer multiplies a radio signal by two-phase local signals of phases that differ from each other by n. For this reason, the differential component of the two-phase baseband signals obtained as a result of the multiplication does not contain any signal component based on an even-order harmonic component of the local signal. In other words, the two-phase mixer does not exhibit sensitivity to an interfering wave having a frequency in the vicinity of an even multiple of the fundamental frequency of the local signal (i.e., even multiple of fundamental frequency+baseband frequency).

According to JP-A 2007-43290 (KOKAI), a three-phase mixer is adopted for the multiplier. The mixer multiplies a radio signal individually by three-phase local signals of phases that are different from one another by 2π/3. The three-phase baseband signals obtained as a result of the multiplication by the three-phase mixer are suitably combined and a calculation is performed so that signal components based on harmonic components of the order of multiples of 3 of the fundamental frequency of the local signal can be canceled. In other words, a three-phase mixer such as the multiplier incorporated in JP-A 2007-43290 (KOKAI) does not exhibit sensitivity to any interfering wave of a frequency in the vicinity of integral multiples of the fundamental frequency of the local signal as long as the integral multiples include 3 in their submultiples (i.e., 3x multiples of fundamental frequency (hereinafter, x is a positive integer)+baseband frequency).

With a two-phase mixer, an interfering wave having a frequency in the vicinity of odd multiples of the fundamental frequency of the local signal (i.e., odd multiples of fundamental frequency+baseband frequency) cannot be suppressed. Furthermore, with a three-phase mixer such as the multiplier described in JP-A 2007-43290 (KOKAI), an interfering wave having a frequency in the vicinity of integral multiples of the fundamental frequency of the local signal cannot be suppressed, if the integral multiples do not include 3 in their submultiples (i.e., multiples of (3x−1) of fundamental frequency+baseband frequency, or multiples of (3x−2) of fundamental frequency+baseband frequency).

### BRIEF SUMMARY OF THE INVENTION

According to an aspect of the invention, there is provided a receiver comprising: a multiphase mixer that multiplies a received radio signal by multiphase local signals the number of which is the same as an integer having a first prime factor and a second prime factor different from the first prime factor, and generates first multiphase baseband signals the number of which is the same as the integer; a first processing circuit that suppresses common modes for first multiphase signal groups formed by dividing the first multiphase baseband signals into groups of signals the number of which is the same as the first prime factor, and generates second multiphase baseband signals; and a second processing circuit that suppresses common modes for second multiphase signal groups formed by dividing the second multiphase baseband signals into groups of signals the number of which is the same as the second prime factor, and generates third multiphase baseband signals.

According to another aspect of the invention, there is provided a frequency converting circuit comprising: a multiphase mixer that multiplies a received radio signal by multiphase local signals the number of which is the same as an integer having a first prime factor and a second prime factor that is different from the first prime factor, and generates first multiphase baseband signals the number of which is the same as the integer; a first processing circuit that suppresses common modes for first multiphase signal groups formed by dividing the first multiphase baseband signals into groups of signals the number of which is the same as the first prime factor, and generates second multiphase baseband signals; and a second processing circuit that suppresses common modes for second multiphase signal groups formed by dividing the second multiphase baseband signals into groups of signals the number of which is the same as the second prime factor, and generates third multiphase baseband signals.

### BRIEF DESCRIPTION OF THE SEVERAL VIEWS OF THE DRAWING

FIG. 1 is a block diagram of part of a receiver according to the first embodiment.

FIG. 2 is a block diagram of an example structure of filters and common mode detectors illustrated in FIG. 1.

FIG. 3 is a block diagram of part of the receiver according to the first embodiment.

FIG. 4 is a diagram explaining interfering wave suppression performed by the receiver of FIG. 3.

FIG. 5 is a diagram showing an example of a process performed by a redundant component reduction circuit that reduces redundant components of two-phase signals.

FIG. 6 is a diagram showing an example of a process performed by a redundant component reduction circuit that reduces redundant components of three-phase signals.

FIG. 7 is a block diagram showing an example structure of the filters and common mode detectors illustrated in FIG. 3.

FIG. 8 is a table showing theoretical values of conversion gains when a common-mode suppressing process is performed onto a multiphase baseband signal.

FIG. 9 is a graph showing the reception performance of the receiver illustrated in FIG. 3 when receiving a target radio signal.

FIG. 10 is a graph showing the reception performance of the receiver illustrated in FIG. 3 in reception of an interfering wave having a frequency in the vicinity of double the fundamental frequency of the local signal.

FIG. 11 is a graph showing the reception performance of the receiver illustrated in FIG. 3 in reception of an interfering wave having a frequency in the vicinity of three times the fundamental frequency of the local signal.

FIG. 12 is a graph showing the reception performance of the receiver illustrated in FIG. 3 in reception of an interfering wave having a frequency in the vicinity of four times the fundamental frequency of the local signal.

FIG. 13 is a graph showing the reception performance of the receiver illustrated in FIG. 3 in reception of an interfering wave having a frequency in the vicinity of five times the fundamental frequency of the local signal.

FIG. 14 is a graph showing the reception performance of the receiver illustrated in FIG. 3 in reception of an interfering wave having a frequency in the vicinity of six times the fundamental frequency of the local signal.

FIG. 15 is a graph showing the reception performance of the receiver illustrated in FIG. 3 in reception of an interfering wave having a frequency in the vicinity of seven times the fundamental frequency of the local signal.

FIG. 16 is a block diagram of part of a receiver according to the second embodiment.

FIG. 17 is a block diagram of an example structure of a delta sigma ADC illustrated in FIG. 16.

FIG. 18 is a block diagram showing an example of a loop filter adopted in the delta sigma ADC of FIG. 16.

FIG. 19 is a block diagram of part of a receiver according to the third embodiment.

FIG. 20 is a block diagram of an example structure of variable gain amplifiers and common mode detectors illustrated in FIG. 19.

FIG. 21 is a block diagram of an example structure of a variable gain amplifier adopted for the receiver according to the third embodiment.

FIG. 22 is a block diagram of a frequency converting circuit according to the fourth embodiment.

FIG. 23 is a block diagram of the frequency converting circuit according to the fourth embodiment.

FIG. 24 is a circuit diagram showing an example structure of the processing circuit illustrated in FIG. 23.

### DETAILED DESCRIPTION OF THE INVENTION

Embodiments of the present invention will now be explained with reference to the attached drawings. The output signal of a mixer includes not only a frequency component of a difference between the radio signal (high-frequency signal) and the local signal, but also a frequency component of a sum of these signals. However, the sum frequency component can be easily suppressed by a filtering process. Therefore, in the following explanation, the output signal of the mixer is referred to as a baseband signal for the sake of convenience.

### First Embodiment

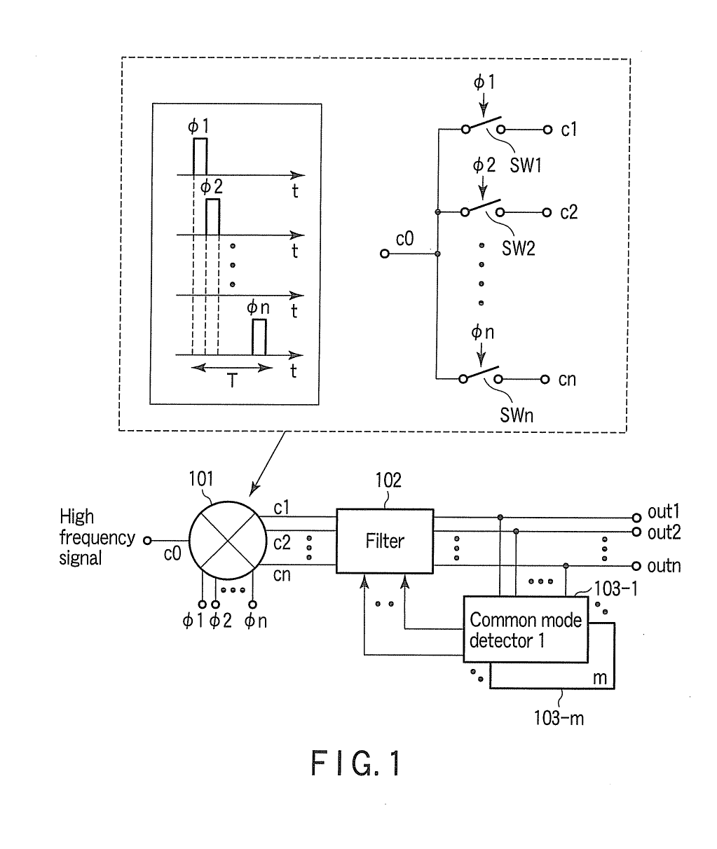

As illustrated in FIG. 1, the receiver according to the first embodiment of the present invention comprises at least an n-phase mixer 101, a filter 102 and a number m (m is an integer equal to or larger than 2) of common mode detectors 103-1 to 103-m. FIG. 1 does not show an antenna, a low noise amplifier (LNA), a variable gain amplifier, an analog-to-digital converter (ADC), a digital signal processing unit and the like that are usually required for the radio signal reception process. Any person skilled in the art would, however, be able to constitute a receiver by combining these components in accordance with the following explanation.

A high frequency signal c0 received by way of a not-shown antenna is input into the n-phase mixer 101. Here, n is an integer obtained by multiplying the number m of prime numbers p1, . . . , pm that are different from one another. In other words, n is an integer having at least two different prime factors. For example, n is 6, which is the product of prime numbers 2 and 3; 15, which is the product of prime numbers 3 and 5; or 30, which is the product of prime numbers 2, 3 and 5. The n-phase mixer 101 multiplies the high frequency signal c0 by n-phase local signals Φ1, . . . , Φn, to obtain n-phase baseband signals c1, . . . , cn.

Here, n-phase local signals Φ1, . . . , Φn are the number n of signals whose phases differ by 2π/n from one another. For example, they are square pulses of the cycle T (i.e., fundamental frequency 1/T) and the duty ratio 1/n, as indicated in FIG. 1. The n-phase mixer 101 is constituted of the number n of switches SW1, . . . , SWn that receive a common high frequency signal c0, as illustrated in FIG. 1. The number n of switches SW1, . . . , SWn are ON/OFF controlled by the n-phase local signals Φ1, . . . , Φn in a one-to-one relationship. In other words, the switch SW1 is turned on when the local signal Φ1 that is input to the control terminal is at a high level, and is thereby short-circuited between the input and output terminals. When the local signal Φ1 is at a low level, the switch SW1 is turned OFF, and is thereby open between the input and output terminals. Similarly, the switch SWn is turned on when the local signal Φn is at a high level, while it is turned off when the local signal Φn is at a low level. By turning the switches SW1, . . . , SWn on/off, the high frequency signal c0 is multiplied by the n-phase local signals Φ1, . . . , Φn so as to generate the n-phase baseband signals c1, . . . , cn, respectively. The n-phase mixer 101 inputs the n-phase baseband signals c1, . . . , cn obtained as multiplication results to the filter 102.

The filter 102 performs a predetermined filtering process on the n-phase baseband signals c1, . . . , cn supplied by the n-phase mixer 101 and generates output signals out1, . . . , outn. As a result of this filtering process, a function of limiting the band of the n-phase baseband signals (hereinafter, simply referred to as “band limiting function”) and a function of suppressing the common mode based on feedback supplied by the number m of common mode detectors 103-1, . . . , 103-m (hereinafter, simply referred to as common mode suppressing function), which will be described later, are realized. With the band limiting function, necessary frequency components are extracted from the n-phase baseband signals. For example, frequency components that are not in the baseband frequency band of the n-phase baseband signals are suppressed. With the common-mode suppressing function, the common mode is suppressed for the multiphase signal groups corresponding to the number m of prime factors p1, . . . , pm (in the following explanation, multiphase signal groups corresponding to the prime factor p indicates multiphase signals divided into groups of the same number of signals as the prime factor p). For instance, when n=6=2×3, the common mode for groups of three two-phase signals and the common mode for groups of two three-phase signals are individually suppressed by the common-mode suppressing function. By suppressing the common mode for multiphase signal groups corresponding to any one of the prime factors p1, . . . , pm, the filter 102 suppresses an interfering wave of any frequency in the vicinity of the fundamental frequency 1/T of the local signal multiplied by an integer having at least one of prime factors p1, . . . , pm as a submultiple. This means that, when n=6=2×3, the filter 102 can suppress interfering waves of frequencies in the vicinity of the fundamental frequency 1/T multiplied by an integer having 2 and/or 3 as submultiples. More specifically, the filter 102 suppresses interfering waves of frequencies in the vicinity of 2, 3, 4, 6, 8, 9, . . . times the fundamental frequency 1/T.

The number m of common mode detectors 103-1, . . . , 103-m detect a common mode for multiphase signal groups corresponding to each of the prime factors p1, . . . , pm from the output signals out1, . . . , outn of the filter 102. The common mode detectors 103-1, . . . , 103-m send the detected common mode back to the filter 102.

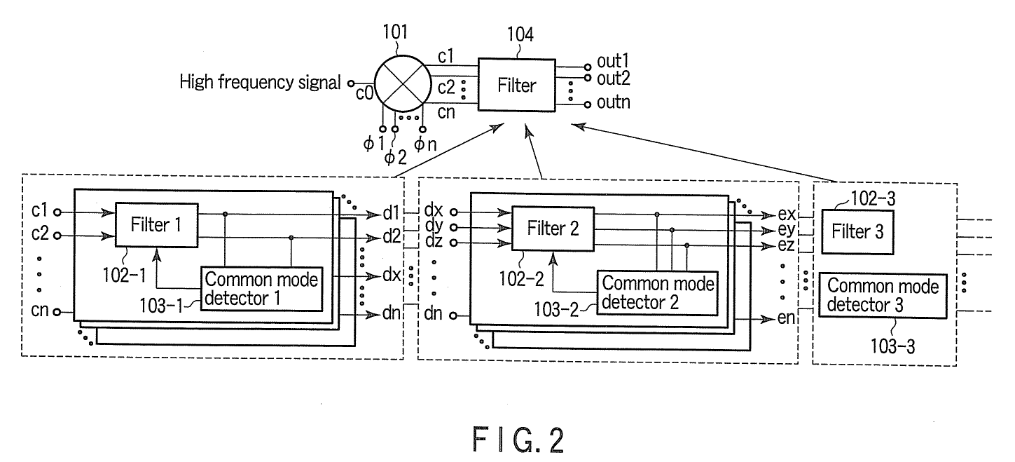

If the filter 102 is a relatively high-order filter, it may be constituted as a filter 104, as illustrated in FIG. 2, by connecting low-order filters 102-1, 102-2, . . . in a cascade form. In the filter 104, the number n/p1 of p1-phase filters 102-1 are provided in the first stage, and a p1-phase common mode feedback circuit (hereinafter, simply referred to as a CMFB circuit) is connected to each of the filters 102-1 as a common mode detector 103-1. In a similar manner, the number n/p2 of p2-phase filters 102-2 are provided in the second stage of the filter 104, and a p2-phase CMFB circuit is connected to each of the filters 102-2 as a common mode detector 103-2. With the filter 104 prepared by cascade-connecting the p1-, . . . , pm-phase filters 102-1, . . . , 102-m, the common mode detectors 103-1, . . . , 103-m can be readily realized by the CMFB circuits which are generally arranged in the filters 102-1, . . . , 102-m.

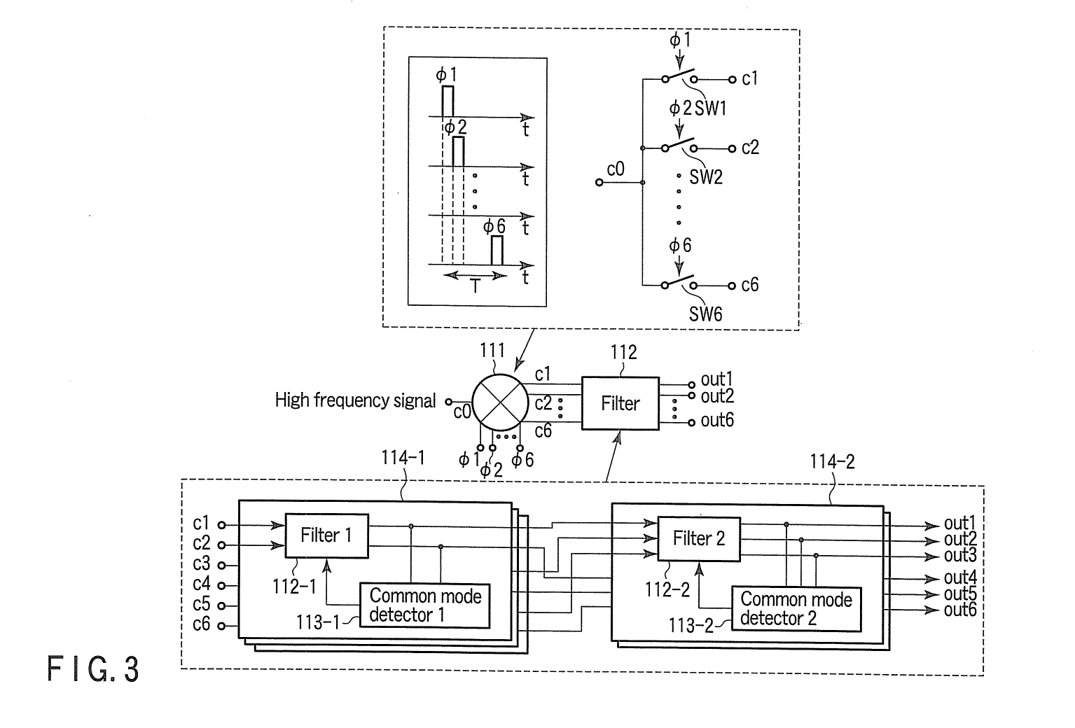

Now, the structure of the receiver according to the present embodiment will be explained in detail with reference to FIG. 3. The receiver of FIG. 3 includes a six-phase mixer 111 and a filter 112. FIG. 3 does not show an antenna, LNA, variable gain amplifier, ADC or digital signal processing unit that are generally required for the reception of a radio signal. However, any person skilled in the art would be able to fabricate the receiver by suitably combining these components in accordance with the following explanation.

A high frequency signal c0 received by way of a not-shown antenna or the like is input to the six-phase mixer 111. The six-phase mixer 111 multiplies the high frequency signal c0 by the six-phase local signals Φ1, . . . , Φ6 to obtain six-phase baseband signals c1, . . . , c6.

Here, the six-phase local signals Φ1, . . . , Φ6 are six signals, the phases of which are different by π/3 from one another, and these signals may be square pulses of a cycle T and duty ratio 1/6, as illustrated in FIG. 3. The six-phase mixer 111 may be composed of six switches SW1, . . . , SW6 that commonly receive the high frequency signal c0, as illustrated in FIG. 3. The six switches SW1, . . . , SW6 are ON/OFF controlled by the six-phase local signals Φ1, . . . , Φ6 in a one-to-one relationship. In other words, the switch SW1 is turned on when the local signal Φ1 is at a high level, and turned off when the local signal Φ1 is at a low level. In a similar manner, the switch SW6 is turned on when the local signal Φ6 is at a high level, and turned off when the local signal Φ6 is at a low level. By turning the switches SW1, . . . , SW6 on/off, the high frequency signal c0 is multiplied by the six-phase local signals Φ1, . . . , Φ6, as a result of which the six-phase baseband signals c1, . . . , c6 are generated. The six-phase mixer 111 inputs the six-phase baseband signals c1, . . . , c6 obtained as multiplication results to the filter 112.

The filter 112 performs a predetermined filtering process on the six-phase baseband signals c1, . . . , c6 supplied by the six-phase mixer 111, and thereby generates the output signals out1, . . . , out6. This filtering process includes a band limiting function, with which frequency components outside the baseband frequency band of the six-phase baseband signals are suppressed, and a common-mode suppressing function, with which the common mode for two-phase signal groups and the common mode for three-phase signal groups are suppressed.

The filter 112 is constituted of filters 114-1 and 114-2 that are connected in a cascade form, as illustrated in FIG. 3. The filter 112 is provided with three two-phase filters 112-1 in the first stage, and a two-phase CMFB circuit is connected to each of the filters 112-1 as a common mode detector 113-1. In a similar manner, the filter 112 is provided with two three-phase filters 112-2 in the second stage, and a three-phase CMFB circuit is connected to each of the filters 112-2 as a common mode detector 113-2.

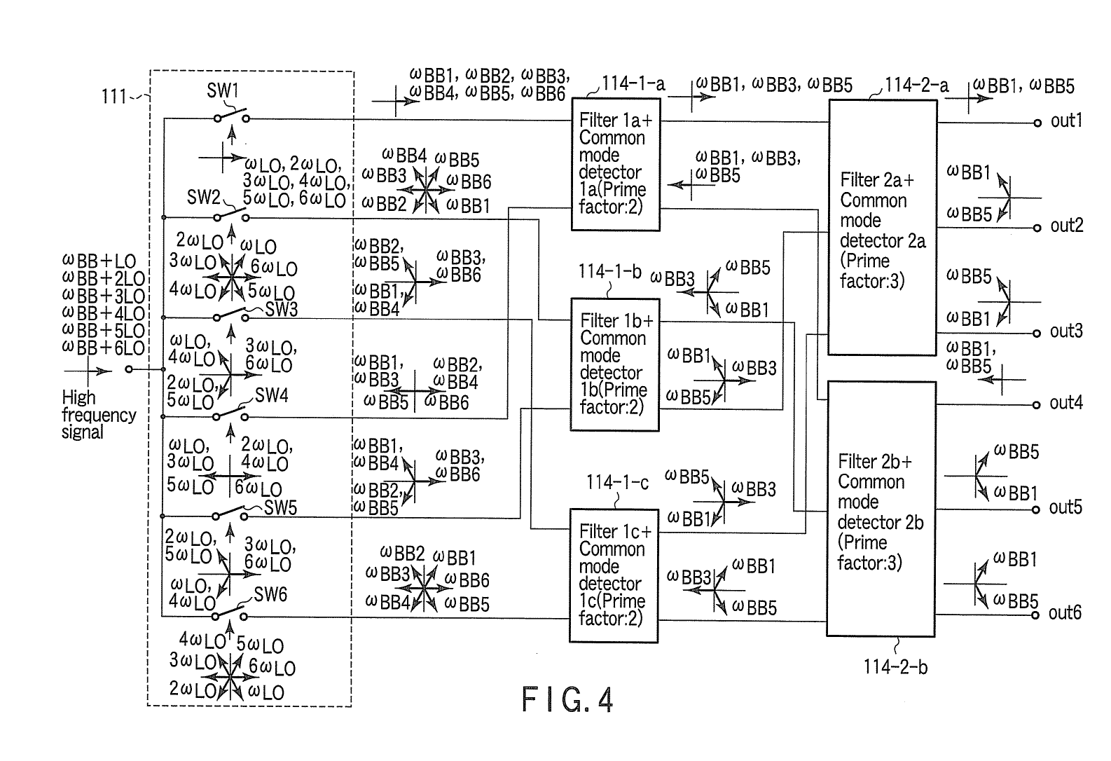

Now, the principle of the interfering wave suppressing operation performed by the receiver of FIG. 3 will be explained with reference to FIG. 4.

It is assumed here that the high frequency signal c0 that is input to the six-phase mixer 111 includes the first to fifth interfering waves in addition to a target radio signal. The frequency of the target radio signal is ωBB+LO. The first to fifth interfering waves are signals having frequencies in the vicinity of two, three, four, five, and six times the fundamental frequency ωLO of the local signal, respectively. Specifically, the frequencies of these interfering waves are ωBB+2LO, ωBB+3LO, ωBB+4LO, ωBB+5LO and ωBB+6LO, respectively.

The switch SW1 is controlled by the local signal Φ1 of the fundamental frequency ωLO and phase=0. The local signal Φ1 includes, in addition to the fundamental frequency component, the second-order harmonic component (phase=0), the third-order harmonic component (phase=0), the fourth-order harmonic component (phase=0), the fifth-order harmonic component (phase=0) and the sixth-order harmonic component (phase=0). As a result of the multiplication performed by the switch SW1, a baseband signal c1 is generated. The baseband signal c1 contains various signal components of frequencies resulting from the product of the target radio signal and first to fifth interfering waves and the local signal. The following explanation, however, will focus on only six signal components that are described below, among the components contained in the baseband signal cl. It is assumed that the other frequency components are to be sufficiently suppressed by the band limiting function of the filter 112.

The six signal components are: (1) a signal component of a frequency ωBB1 (phase=0), which is a difference between the frequency ωBB+LO of the target radio signal and the fundamental frequency ωLO of the local signal; (2) a signal component of a frequency ωBB2 (phase=0), which is a difference between the frequency ωBB+2LO of the first interfering wave and the frequency 2ωLO of the second harmonic wave of the local signal; (3) a signal component of a frequency ωBB3 (phase=0), which is a difference between the frequency ωBB+3LO of the second interfering wave and the frequency 3ωLO of the third harmonic wave of the local signal; (4) a signal component of a frequency ωBB4 (phase=0), which is a difference between the frequency ωBB+4LO of the third interfering wave and the frequency 4ωLO of the fourth harmonic wave of the local signal; (5) a signal component of a frequency ωBB5 (phase=0), which is a difference between the frequency ωBB+5LO of the fourth interfering wave and the frequency 5ωLO of the fifth harmonic wave of the local signal; and (6) a signal component of a frequency ωBB6 (phase=0), which is a difference between the frequency ωBB+6LO of the fifth interfering wave and the frequency 6ωLO of the sixth harmonic wave of the local signal. The explanation of the baseband signals c2, . . . , c6 generated by other switches SW2, . . . , SW6 will also focus on these six signal components. It should be noted that, as shown in FIG. 4, the six signal components contained in each of the baseband signals c1, . . . , c6 are different from one another in phase.

Among the baseband signals c1, . . . , c6, a pair of signals (two-phase signal group) having signal components of the frequencies ωBB2, ωBB4 and ωBB6 in phase are input to each of the filters 114-1-a, 114-1-b and 114-1-c in the first stage. In other words, the baseband signals c1 and c4 (all the phases of the signal components of the frequencies ωBB2, ωBB4 and ωBB6 being 0) are input to the filter 114-1-a; the baseband signals c2 and c5 (the phases of the signal components of the frequencies ωBB2, ωBB4 and ωBB6 being 4π/3, 2π/3 and 0) are input to the filter 114-1-b; and the baseband signals c3 and c6 (the phases of the signal components of the frequencies ωBB2, ωBB4 and ωBB6 being 2π/3, 4π/3 and 0) are input to the filter 114-1-c.

Each of the filters 114-1-a, 114-1-b and 114-1-c is provided with a two-phase CMFB circuit, with which the common mode of an input signal can be suppressed. That is, the filters 114-1-a, 114-1-b and 114-1-c suppress signal components of the frequencies ωBB2, ωBB4 and ωBB6 in the input signal. The positive phase output signal of the filter 114-1-a (all the phases of the signal components of the frequencies ωBB1, ωBB3 and ωBB5 are 0) is input to the filter 114-2-a, while the negative phase output signal of the filter 114-1-a is input to the filter 114-2-b. The positive phase output signal of the filter 114-1-b (the phases of the signal components of the frequencies ωBB1, ωBB3 and ωBB5 are 5π/3, π and π/3, respectively) is input to the filter 114-2-b, and the negative phase output signal of the filter 114-1-b is input to the filter 114-2-a. The positive phase output signal of the filter 114-1-c (the phases of the signal components of the frequencies ωBB1, ωBB3 and ωBB5 are 4π/3, 0 and 2π/3, respectively) is input to the filter 114-2-a, and the negative phase output signal of the filter 114-1-c is input to the filter 114-2-b.

The filters 114-2-a and 114-2-b each have a three-phase CMFB circuit, and suppress the common mode of the input signal by use of this CMFB circuit. More specifically, the filters 114-2-a and 114-2-b suppress the signal component of the frequency ωBB3 contained in the input signal. The filter 114-2-a outputs an output signal out1 (the phases of the signal components of the frequencies ωBB1 and ωBB5 both being 0), an output signal out2 (the phases of the signal components of the frequencies ωBB1 and ωBB5 being 2π/3 and 4π/3, respectively), and an output signal out3 (the phases of the signal components of the frequencies ωBB1 and ωBB5 being 4π/3 and 2π/3, respectively). The filter 114-2-b outputs an output signal out4 (the phases of the signal components of the frequencies ωBB1 and ωBB5 both being π) and an output signal out5 (the phases of the signal components of the frequencies ωBB1 and ωBB5 being 5π/3 and π/3, respectively).

As described above, the filter 112 can generate output signals out1, . . . , out6 from the input signals c1, . . . , c6 supplied from the six-phase mixer 111 by suppressing their signal components of the frequencies ωBB2, ωBB3, ωBB4 and ωBB6. The signal components of the frequencies ωBB2, ωBB3, ωBB4 and ωBB6 arise from the aforementioned first, second, third and fifth interfering waves. Hence, the filter 112 can suppress interfering waves of frequencies in the vicinity of the fundamental frequency of the local signal multiplied by integers that have at least one of the prime factors 2 and 3 as a submultiple (i.e., 2, 3, 4, 6, 8, 9, 12, . . . ).

With the current wireless communication technology, most of the signals that are to be processed by the receiver are orthogonal two-phase signals, in other words, an in-phase signal and a quadrature-phase signal. On the other hand, the output signals of the filter 112 have six phases. If orthogonal two-phase signals are to be processed downstream of the process at the filter 112, a process may be performed so as to remove redundant components from the output signals.

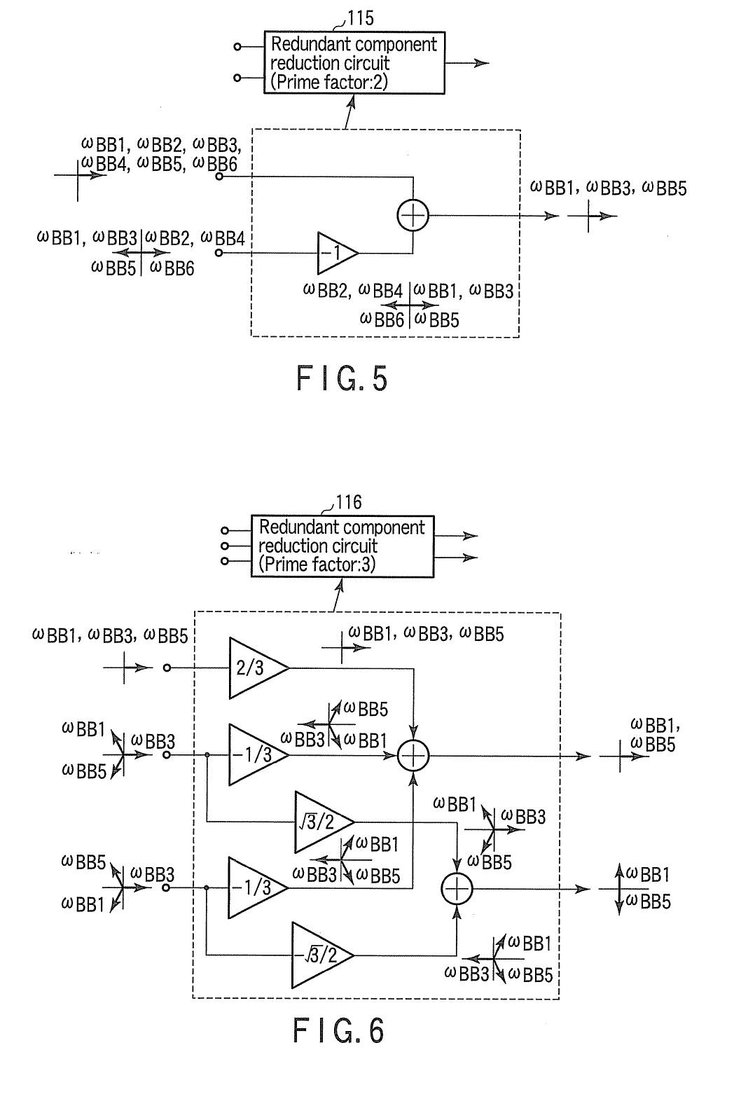

For instance, the filters 114-1-a, 114-1-b and 114-1-c of FIG. 4 can be used as a redundant component reduction circuit that performs signal processing as indicated in FIG. 5. The redundant component reduction circuit of FIG. 5 generates an output signal by adding one of the 2-phase input signals to the other input signal multiplied by −1. Hence, the redundant component reduction circuit of FIG. 5 suppresses the common mode of the two-phase signal groups, and, at the same time, it eliminates one of the signal lines required for the output signals.

By utilizing the filters 114-1-a, 114-1-b and 114-1-c of FIG. 4 as the redundant component reduction circuit of FIG. 5, the filter 114-2-b becomes no longer necessary. In such a case, the filter 114-2-a can be used as a redundant component reduction circuit that performs signal processing as shown in FIG. 6. The redundant component reduction circuit of FIG. 6 performs matrix calculation as indicated in Expression (1) on the 3-phase input signals D1, D2 and D3 in order to obtain orthogonal two-phase signals D1 and DQ.

$$[ \begin{matrix}{D}_{I} \\ {D}_{Q}\end{matrix} ] = [ \begin{matrix}\frac{2}{3} & - \frac{1}{3} & - \frac{1}{3} \\ 0 & \frac{\sqrt{3}}{2} & - \frac{\sqrt{3}}{2}\end{matrix} ] [ \begin{matrix}{D}_{1} \\ {D}_{2} \\ {D}_{3}\end{matrix} ] \qquad ( 1 )$$

In other words, the redundant component reduction circuit of FIG. 6 generates the in-phase signal DI from the sum of the input signal D1 multiplied by ⅔, the input signal D2 multiplied by −⅓, and the input signal D3 multiplied by −⅓. Moreover, the redundant component reduction circuit of FIG. 6 generates the quadrature-phase signal DQ from the sum of the input signal D2 multiplied by \sqrt{3}/2 and the input signal D3 multiplied by −\sqrt{3}/2. In this manner, the redundant component reduction circuit of FIG. 5 suppresses the common mode of the three-phase signal groups, while it eliminates one of the signal lines required for the output signals.

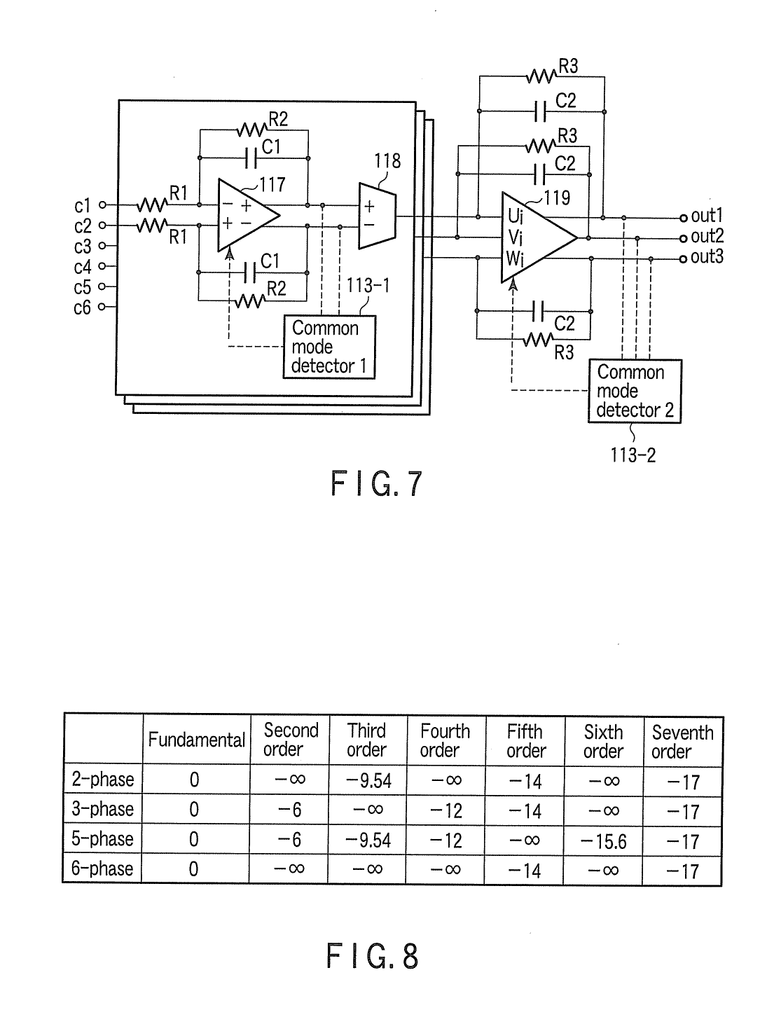

The filter 112 of FIG. 3 may be constituted as a filter illustrated in FIG. 7. The filter of FIG. 7 is prepared by connecting two stages of primary filters in the form of a cascade. The first stage includes three two-phase filters, and the second stage includes a single three-phase filter.

Each of the two-phase filters in the first stage is a primary low-pass filter comprising a differential operational amplifier 117, a register, a capacitor and a common mode detector 113-1. The differential output of each two-phase filter in the first stage is subjected to a differential-single phase conversion by a voltage controlled current source 118, and input to the three-phase filter in the second stage. The three-phase filter in the second stage is a primary low-pass filter comprising a three-phase operational amplifier 119, a register, a capacitor and a common mode detector 113-2.

The structure of the filter indicated in FIG. 7 is given merely as an example. That is, the filter of the receiver according to the present embodiment is not limited to the structure incorporating an operational amplifier, and may be designed to include a voltage controlled current source or a switched capacitor circuit. Furthermore, the filter of the receiver according to the present embodiment is not limited to the structure having multi-stages of the primary filters, and may be provided with multi-stages of secondary or higher-order filters. The filter may be constituted of a single stage.

FIG. 8 indicates theoretical values of the conversion gains for signal components of the target radio signal and of the interfering waves (having frequencies in the vicinity of two-, three-, four-, five-, six-, and seven-times the fundamental frequency of the local signal), when common-mode suppressing operations of the two-phase signal, the three-phase signal, the five-phase signal and the six-phase signal (i.e., for two-phase signal groups and for three-phase signal groups) are performed on the multiphase baseband signal. According to the table of FIG. 8, when the common-mode suppressing operations of the two-phase signal, the three-phase signal and the five-phase signal are performed, interfering waves of frequencies in the vicinity of the fundamental frequency of the local signal multiplied by any integer having 2, 3 or 5, respectively, as a submultiple can be suppressed. In addition, according to the table of FIG. 8, when the common-mode suppressing operation of the six-phase signal is performed, interfering waves of frequencies in the vicinity of the fundamental frequency of the local signal multiplied by integers having at least either one of 2 and 3 (prime factors of 6) as a submultiple can be suppressed.

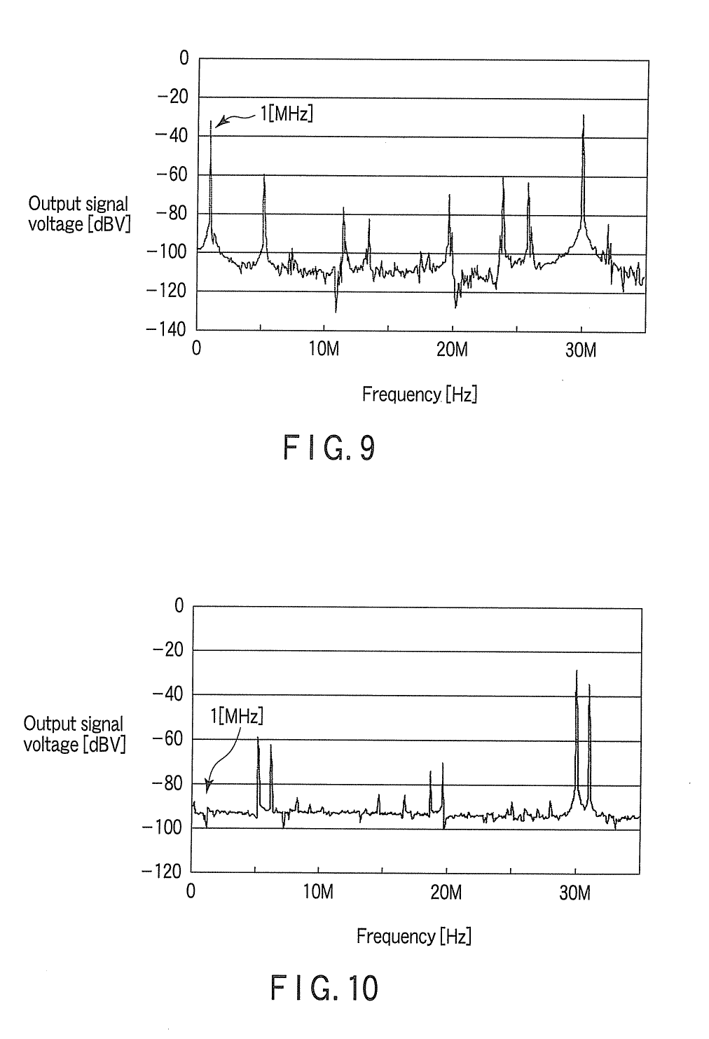

The simulation result of the common-mode suppression of the six-phase signal performed by the receiver of FIG. 3 will be explained with reference to FIGS. 9 to 15.

FIG. 9 shows the results of a Fourier transform performed on output signals that are obtained from the common-mode suppression of the six-phase signal when the target radio signal has an amplitude of 100 μA and a frequency of 31 MHz, and the local signal has an amplitude of 600 mV and a frequency of 30 MHz. The filter 112 exhibits an amplitude characteristic of gain 1 in its passband, and the common mode suppression is realized by way of ideal elements. In the simulation of FIG. 9, the baseband frequency is 1 MHz, which is a difference between the frequency 31 MHz of the target radio signal and the fundamental frequency of the local signal 30 MHz. Thus, according to FIG. 9, the receiver of FIG. 3 exhibits sensitivity to the target radio signal.

FIG. 10 indicates the results of a Fourier transform performed on output signals that are obtained from the common-mode suppression of the six-phase signal when an interfering wave of a frequency in the vicinity of double the fundamental frequency of the local signal has an amplitude of 100 μA and a frequency of 61 MHz. In the simulation of FIG. 10, the conditions of the local signal and filter characteristics are the same as those in FIG. 9. As can be seen from FIG. 10, a signal component of 1 MHz that corresponds to a difference between the frequency 61 MHz of the interfering wave and the frequency 60 MHz of the second harmonic wave of the local signal is sufficiently suppressed. Thus, according to FIG. 10, the receiver of FIG. 3 does not exhibit sensitivity to this interfering wave.

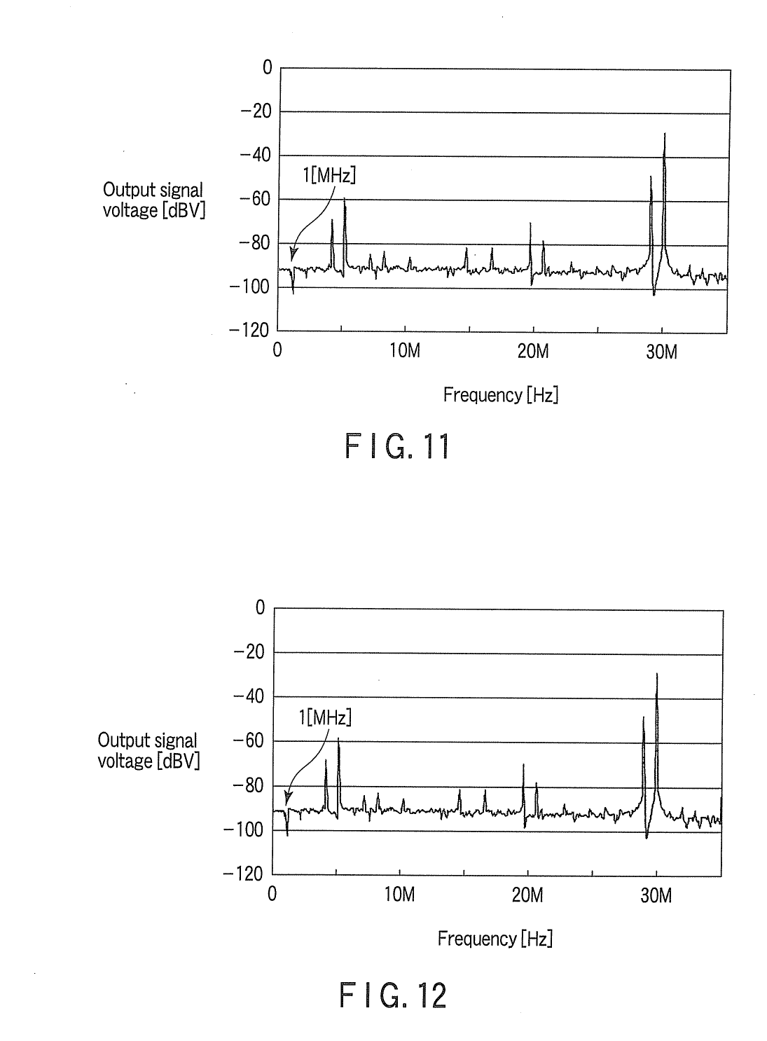

FIG. 11 indicates the results of a Fourier transform performed on output signals that are obtained from the common-mode suppression of the six-phase signal when the interfering wave of a frequency in the vicinity of three times the fundamental frequency of the local signal has an amplitude of 100 μA and a frequency of 91 MHz. In the simulation of FIG. 11, the conditions of the local signal and filter characteristics are the same as those in FIGS. 9 and 10. As can be seen from FIG. 11, a signal component of 1 MHz, which corresponds to a difference between the frequency 91 MHz of the interfering wave and the frequency 90 MHz of the third harmonic wave of the local signal, is sufficiently suppressed. Thus, according to FIG. 11, the receiver of FIG. 3 does not exhibit sensitivity to the interfering wave.

FIG. 12 indicates the results of a Fourier transform performed on output signals that are obtained from the common-mode suppression of the six-phase signal when the interfering wave of a frequency in the vicinity of four times the fundamental frequency of the local signal has an amplitude of 100 μA and a frequency of 121 MHz. In the simulation of FIG. 12, the conditions of the local signal and the filter characteristics are the same as those in FIGS. 9 to 11. As can be seen from FIG. 12, a signal component of 1 MHz, which corresponds to a difference between the frequency of 121 MHz of the interfering wave and the frequency 120 MHz of the fourth harmonic wave of the local signal is sufficiently suppressed. Thus, according to FIG. 12, the receiver of FIG. 3 does not exhibit sensitivity to the interfering wave.

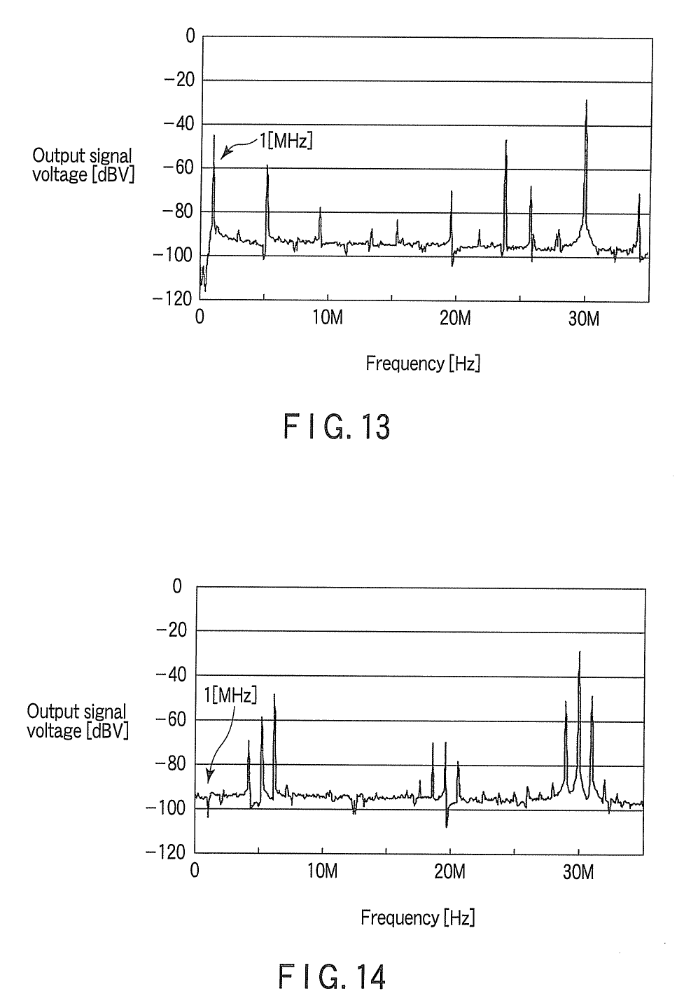

FIG. 13 indicates the results of a Fourier transform performed on output signals that are obtained from the common-mode suppression of the six-phase signal when the interfering wave of a frequency in the vicinity of five times the fundamental frequency of the local signal has an amplitude of 100 μA and a frequency of 151 MHz. In the simulation of FIG. 13, the conditions of the local signal and the filter characteristics are the same as those in FIGS. 9 to 12. As can be seen from FIG. 13, a signal component of 1 MHz, which corresponds to a difference between the frequency 151 MHz of the interfering wave and the frequency 150 MHz of the fifth harmonic wave of the local signal, is not suppressed. Thus, according to FIG. 13, the receiver of FIG. 3 exhibits sensitivity to the interfering wave. The simulation results of FIG. 13 agree with the ideal conversion gains indicated in FIG. 8.

FIG. 14 indicates the results of a Fourier transform performed on output signals that are obtained from the common-mode suppression of the six-phase signal when the interfering wave of a frequency in the vicinity of six times the fundamental frequency of the local signal has an amplitude of 100 μA and a frequency of 181 MHz. In the simulation of FIG. 14, the conditions of the local signal and the filter characteristics are the same as those in FIGS. 9 to 13. As can be seen from FIG. 14, a signal component of 1 MHz, which corresponds to a difference between the frequency 181 MHz of the interfering wave and the frequency 180 MHz of the sixth harmonic wave of the local signal is sufficiently suppressed. Thus, according to FIG. 14, the receiver of FIG. 3 does not exhibit sensitivity to the interfering wave.

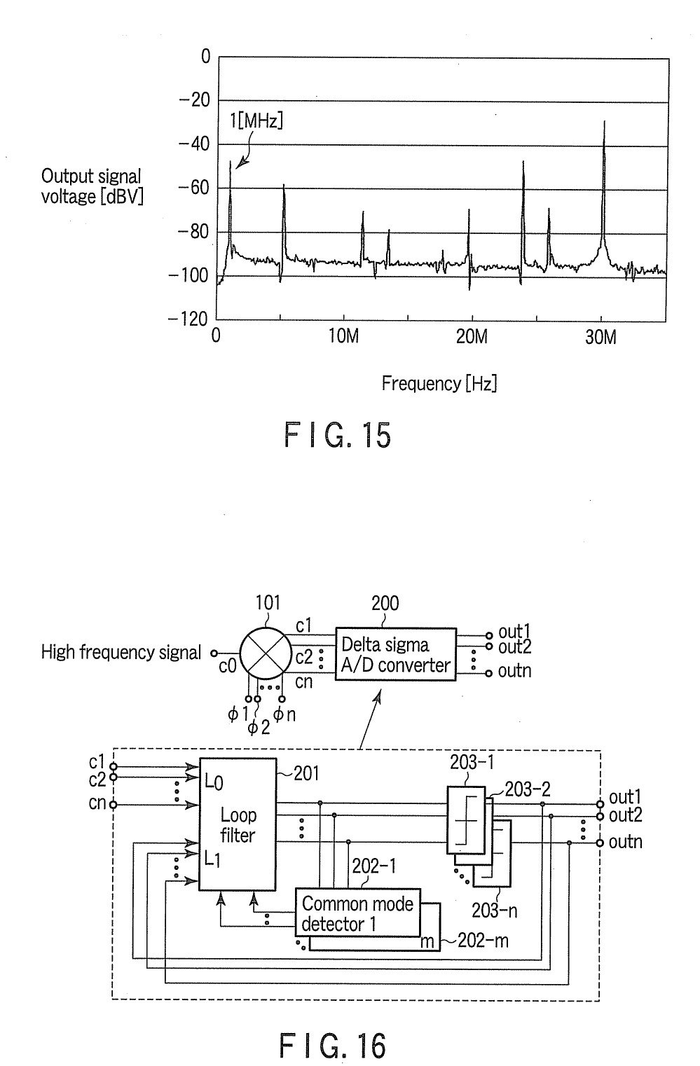

FIG. 15 indicates the results of a Fourier transform performed on output signals that are obtained from the common-mode suppression of the six-phase signal when the interfering wave of a frequency in the vicinity of seven times the fundamental frequency of the local signal has an amplitude of 100 μA and a frequency of 211 MHz. In the simulation of FIG. 15, the conditions of the local signal and the filter characteristics are the same as those in FIGS. 9 to 14. As can be seen in FIG. 15, the signal component of 1 MHz, which corresponds to a difference between the frequency 211 MHz of the interfering wave and the frequency 210 MHz of the seventh harmonic wave of the local signal, is not suppressed. Thus, according to FIG. 15, the receiver of FIG. 3 exhibits sensitivity to this interfering wave. The simulation results of FIG. 15 agree with the ideal conversion gains indicated in FIG. 8.

As discussed above, the receiver according to the present embodiment generates multiphase baseband signals by multiplying the radio signal by the same number of multiphase local signals as an integer n having the number m of different prime factors p1, . . . , pm, and thereby suppresses the common mode for the multiphase signal groups having the same number of signals as any one of prime factors p1, . . . , pm. Hence, the receiver according to the present embodiment can suppress interfering waves of frequencies in the vicinity of the fundamental frequency of the local signal multiplied by any integer that includes at least one of prime factors p1, . . . , pm as a submultiple.

In particular, in the receiver according to the present embodiment, the filter generally used for limiting the band of the radio signal is configured by connecting m stages of filters that have CMFB circuits with respect to the number of multiphase signals corresponding to any one of the prime factors p1, . . . , pm. Hence, the receiver according to the present embodiment can readily realize suppression of the common mode for multiphase signal groups having the same number of signals as any one of the prime factors p1, . . . , pm by way of a CMFB circuit provided in the filter.

### Second Embodiment

A receiver according to the second embodiment comprises at least an n-phase mixer 101 and a delta sigma ADC 200, as illustrated in FIG. 16. The n-phase mixer 101 of FIG. 16 is the same as the n-phase mixer 101 according to the first embodiment. FIG. 16 does not show an antenna, an LNA, filters, a variable gain amplifier, a digital signal processing unit and the like that are required for radio signal reception. Any person skilled in the art, however, would be able to construct the receiver by suitably combining these components in accordance with the following explanation.

The delta sigma ADC 200 performs analog-to-digital conversion on an n-phase baseband signal supplied from the n-phase mixer 101, and thereby outputs digital signals out1, . . . , outn. The number of digital signals out1, . . . , outn is smaller than n when signal processing for redundant component reduction is performed, as in the explanation given with reference to FIGS. 5 and 6, for example. As shown in FIG. 16, the delta sigma ADC 200 comprises a loop filter 201, the number m of common mode detectors 202-1, . . . , 202-m and quantizers 203-1, . . . , 203-n.

The loop filter 201 includes a group of input terminals L0 to which the n-phase baseband signals c1, . . . , cn are supplied from the n-phase mixer 101, and a group of input terminals L1 to which at most the number n of feedback signals are supplied from the quantizers 203-1, . . . , 203-n. The loop filter 201 achieves a gain of at least 1 in an intended signal band. The loop filter 201 inputs combined signals formed from the received n-phase baseband signals c1, . . . , cn and feedback signals, to the quantizers 203-1, . . . , 203-n. Because the feedback signals are digital signals, the digital-to-analog conversion may be performed suitably within the loop filter 201 or before the signals are input to the loop filter 201.

Furthermore, the loop filter 201 is provided with the aforementioned common-mode suppressing function. That is, the loop filter 201 suppresses the common mode for the multiphase signal groups corresponding to each of the number m of prime factors p1, . . . , pm, based on the feedback from the number m of common mode detectors 202-1, . . . , 202-m, which will be described later. The loop filter 201 suppresses the common mode for the multiphase signal groups corresponding to each of the prime factors p1, . . . , pm, and thereby suppresses interfering waves of frequencies in the vicinity of the fundamental frequency of the local signal multiplied by any integer that includes at least one of the prime factors p1, . . . , pm as a submultiple.

The number m of common mode detectors 202-1, . . . , 202-m individually detect the common mode for the multiphase signal groups corresponding to each of the prime factors p1, . . . , pm from the output signals of the loop filter 201. Each of the common mode detectors 202-1, . . . , 202-m sends the detected common mode back to the loop filter 201.

The quantizers 203-1, . . . , 203-n quantize the signals input by the loop filter 201 to convert to digital signals out1, . . . , outn. The quantizers 203-1, . . . , 203-n send the digital signals out1, . . . , outn back to the input terminal group L1 of the loop filter 201, and also output them as output signals of the delta-sigma ADC 200.

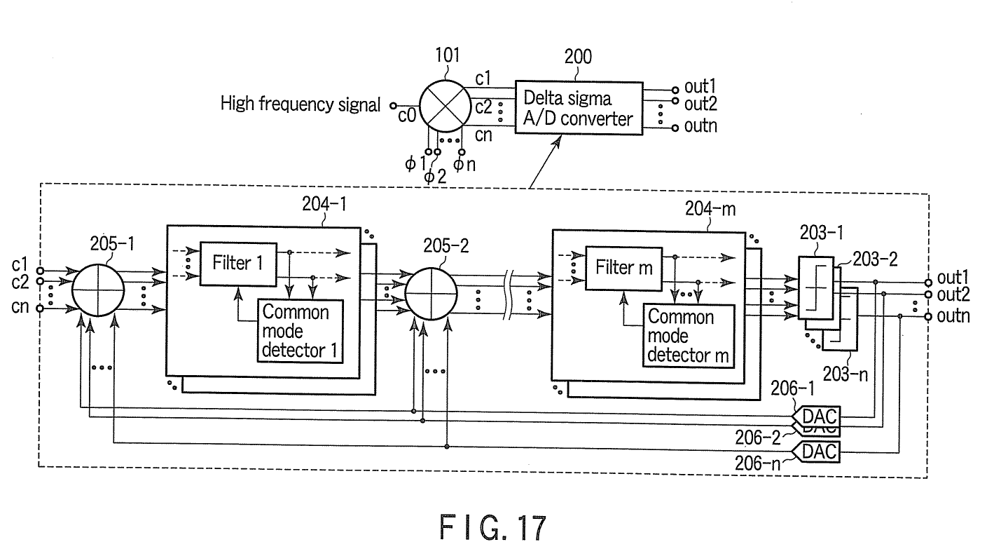

If the loop filter 201 is a relatively high-order filter, lower-order filters may be connected to one another in the form of a cascade, as illustrated in FIG. 17. The loop filter of FIG. 17 is constituted by cascade-connecting low-order filters 204-1, . . . , 204-m, and arranging n-phase adders 205-1, . . . , 205-m before the filters 204-1, . . . , 204-m, respectively.

In the filter 204-1, the number n/p1 of p1-phase filters are arranged. Similarly, in the filter 204-m, the number n/pm of pm-phase filters are arranged. The filters 204-1, . . . , 204-m perform a filtering process on the signals supplied by the n-phase adders 205-1, . . . , 205-m, and this process includes at least common-mode suppression that incorporates common mode detectors realized by the CMFB circuits.

The n-phase adder 205-1 adds the n-phase baseband signal supplied by the n-phase mixer 101 to the n-phase feedback signals supplied by the DACs 206-1, . . . , 206-n that will be described later, and inputs the resultant signals to the subsequent filter 204-1. The n-phase adders 205-2, . . . , 205-(m−1) add the n-phase input signals of the previous filters 204-1, . . . , 204-(m−2) to the n-phase feedback signals of the DAC 206-1, . . . , 206-n, and input the resultant signals to the subsequent filters 204-2, . . . , 204-(m−1). The n-phase adder 205-m adds the n-phase input signals of the previous filter 204-(m−1) to the n-phase feedback signals of the DAC 206-1, . . . , 206-n and inputs the resultant signals to the quantizers 203-1, . . . , 203-n.

The number n of DACs 206-1, . . . , 206-n perform digital-to-analog conversion on the digital signals supplied by the quantizers 203-1, . . . , 203-n, and send the generated analog signals back to the n-phase adders 205-1, . . . , 205-m as n-phase feedback signals.

With the loop filter 201 constructed by cascade-connecting the p1-phase, . . . , pm-phase filters 204-1, . . . , 204-m to one another, the common mode detectors 202-1, . . . , 202-m can be readily realized by the CMFB circuits contained in the filters 204-1, . . . , 204-m.

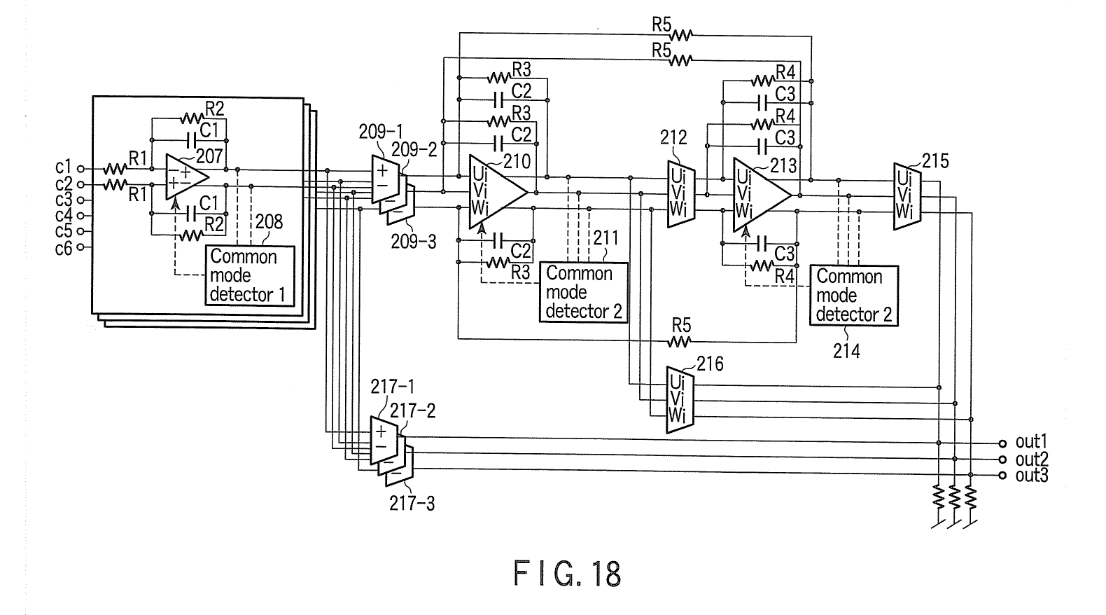

When n=6=2×3, the loop filter of the delta sigma ADC 200 illustrated in FIG. 16 may be formed by a circuit as illustrated in FIG. 18. The loop filter of FIG. 18 is of a continuous-time feedforward type incorporating an operational amplifier. The loop filter of FIG. 18 suppresses the common mode for the two-phase signals by use of the common mode detector 208 and the common mode for the three-phase signals by use of the common mode detectors 211 and 214. The loop filter incorporated in the delta sigma ADC 200 is not limited to the one illustrated in FIG. 18, and may be of a discrete-time type. A voltage controlled current source may be incorporated in place of the operational amplifier.

As discussed above, the receiver according to the present embodiment multiples a radio signal by multiphase local signals the number of which is the same as an integer n having the number m of different prime factors p1, . . . , pm so as to generate multiphase baseband signals, and thereby suppresses the common mode for multiphase signal groups having the same number of signals as each of the prime factors p1, . . . , pm. Hence, the receiver according to the present embodiment suppresses interfering waves of frequencies in the vicinity of the fundamental frequency of the local signal multiplied by any integer including at least one of the prime factors p1, . . . , pm as a submultiple.

Especially, in the receiver according to the present embodiment, a loop filter generally provided in an ADC to perform analog-to-digital conversion on a radio signal is formed by cascade-connecting m stages of low-order filters that have CMFB circuits for multiphase signals the number of which is the same as each of prime factors p1, . . . , pm. Hence, the receiver according to the present embodiment can readily realize suppression of the common mode for multiphase signal groups that include the same number of signals as any one of the prime factors p1, . . . , pm by use of the CMFB circuits arranged in the loop filters of the ADC.

### Third Embodiment

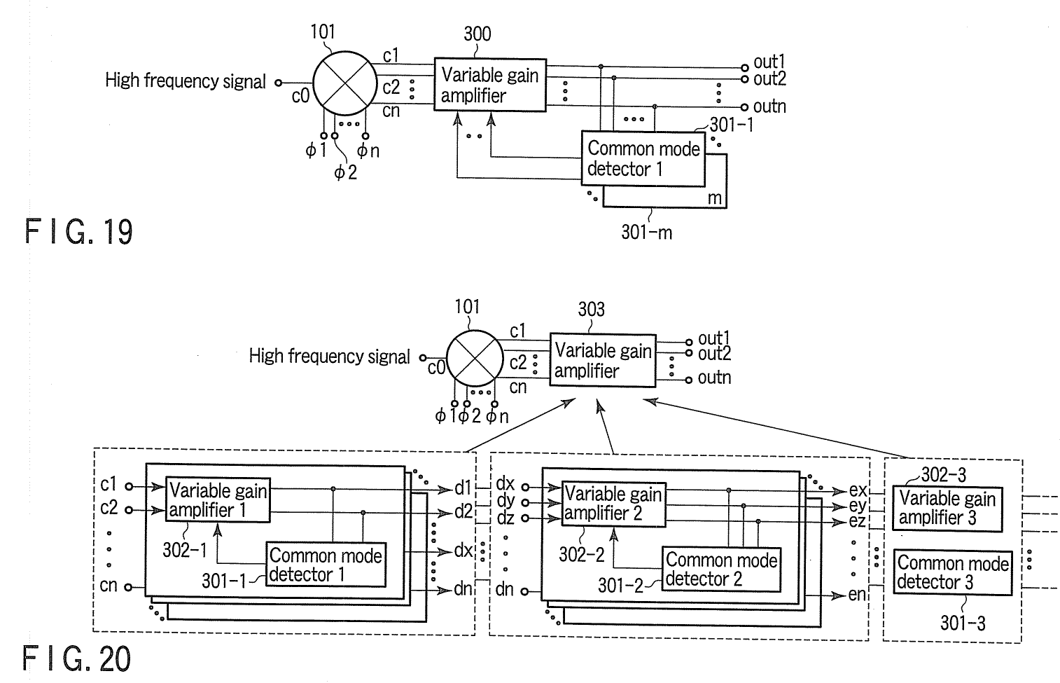

A receiver according to the third embodiment of the present invention comprises at least an n-phase mixer 101, a variable gain amplifier 300 and the number m of common mode detectors 301-1, . . . , 301-m, as illustrated in FIG. 19. The n-phase mixer 101 of FIG. 19 is the same as the n-phase mixer 101 discussed in the first and second embodiments. FIG. 19 does not show an antenna, LNA, filter, ADC, digital signal processing unit or the like that are required for the reception of radio signals. However, any person skilled in the art would be able to constitute a receiver by suitably combining these components in accordance with the following explanation.

The variable gain amplifier 300 amplifies the signal level of the n-phase baseband signals supplied from the n-phase mixer 101, and outputs the output signals out1, . . . , outn. The number of output signals out1, . . . , outn is smaller than n if signal processing is performed to reduce redundant components as previously discussed with reference to FIGS. 5 and 6.

The variable gain amplifier 300 is provided with the aforementioned common-mode suppressing function. In other words, the variable gain amplifier 300 suppresses the common mode for multiphase signal groups corresponding to each of the number m of prime factors p1, . . . , pm of the integer n, based on the feedback from the number m of common mode detectors 301-1, . . . , 301-m, which will be described later. The variable gain amplifier 300 suppresses the common mode for multiphase signal groups corresponding to each of the prime factors p1, . . . , pm, and thereby suppresses interfering waves having frequencies in the vicinity of the fundamental frequency of the local signal multiplied by any integer having at least one of the prime factors p1, . . . , pm.

The number m of common mode detectors 301-1, . . . , 301-m detect the common mode for the multiphase signal groups corresponding to the prime factors p1, . . . , pm, respectively, from the output signals of the variable gain amplifier 300. Each of the common mode detectors 301-1, . . . , 301-m sends the detected common mode back to the variable gain amplifier 300.

If the variable gain amplifier 300 is a relatively high-gain amplifier, it may be formed as a variable gain amplifier 303 by cascade-connecting low-gain variable gain amplifiers, as illustrated in FIG. 20. In the first stage of the variable gain amplifier 303, the number n/p1 of p1-phase variable gain amplifiers 302-1 are arranged. A p1-phase CMFB circuit is connected to each of the variable gain amplifiers 302-1 as a common mode detector 301-1. Similarly, in the second stage of the variable gain amplifier 303, the number n/p2 of p2-phase variable gain amplifiers 302-2 are arranged. A p2-phase CMFB circuit is connected to each of the variable gain amplifiers 302-2 as a common mode detector 301-2. By forming the variable gain amplifier 303 by cascade-connecting the p1-phase, . . . , pm-phase variable gain amplifiers 302-1, . . . , 302-m, the common mode detectors 301-1, . . . , 301-m can be readily realized by the CMFB circuits generally provided in the variable gain amplifiers 302-1, . . . , 302-m.

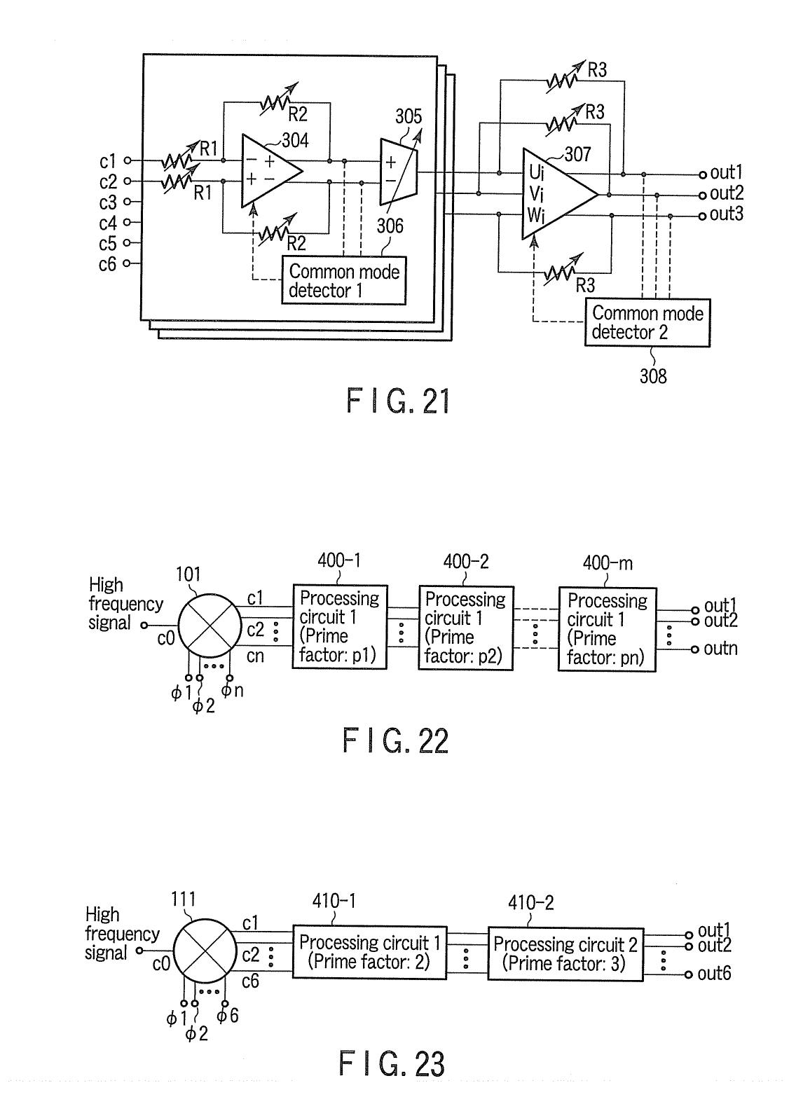

When n=6=2×3, the variable gain amplifier adopted in the receiver according to the present embodiment may be formed by a circuit indicated in FIG. 21. The variable gain amplifier of FIG. 21 suppresses the common mode for two-phase signal groups by use of the common mode detector 306, and also suppresses the common mode for three-phase signal groups by use of the common mode detector 308. The variable gain amplifier adopted for the receiver according to the present embodiment is not limited to an operational amplifier, and a voltage controlled current source may be incorporated.

As described above, the receiver according to the present embodiment multiplies the radio signal by the multiphase local signals the number of which is the same as an integer n having the number m of different prime factors p1, . . . , pm so as to generate multiphase baseband signals, and thereby suppresses the common mode for multiphase signal groups corresponding to any one of prime factors p1, . . . , pm. Hence, the receiver according to the present embodiment can suppress interfering waves of frequencies in the vicinity of the fundamental frequency of the local signal multiplied by any integer including at least one of the prime factors p1, . . . , pm as a submultiple.

Especially, in the receiver according to the present embodiment, the variable gain amplifier, which is generally used to amplify the signal level of the radio signal, can be formed by cascade-connecting m stages of variable gain amplifiers having CMFB circuits to one another for multiphase signals the number of which is the same as any one of the prime factors p1, . . . , pm. For this reason, the receiver according to the present embodiment can readily realize suppression of the common mode for the multiphase signal groups having the same number of signals as any one of prime factors p1, . . . , pm by way of the CMFB circuits provided in the variable gain amplifiers.

### Fourth Embodiment

As shown in FIG. 22, a frequency converting circuit according to the fourth embodiment of the present invention comprises an n-phase mixer 101 and m stages of cascade-connected processing circuits 400-1, . . . , 400-m. The n-phase mixer 101 of FIG. 22 is the same as the n-phase mixer 101 according to the first to third embodiments.

When multiphase signals are received, each of the processing circuits 400-1, . . . , 400-m suppresses the common mode for multiphase signal groups having the same number of signals as any one of the prime factors p1, . . . , pm of an integer n.

The frequency converting circuit of FIG. 22 suppresses interfering waves of frequencies in the vicinity of the fundamental frequency of the local signal multiplied by any integer including at least one of the prime factors p1, . . . , pm as a submultiple.

For instance, the processing target of the frequency converting circuit according to the present embodiment may be six-phase signals as indicated in FIG. 23. The frequency converting circuit of FIG. 23 includes a six-phase mixer 111 and two stages of cascade-connected processing circuits 410-1 and 410-2. In FIG. 23, the six-phase mixer 111 is the same as the six-phase mixer 111 according to the first embodiment.

The processing circuit 410-1 performs the common-mode suppression for two-phase signal groups of the six-phase baseband signals supplied from the six-phase mixer 111, and inputs signals obtained after the common-mode suppression to the processing circuit 410-2. The processing circuit 410-2 performs the common-mode suppression for three-phase signal groups of the input signal supplied by the processing circuit 410-1, and outputs signals obtained after the common-mode suppression. The operations performed by the processing circuits 410-1 and 410-2 may be in inverse order.

The frequency converting circuit of FIG. 23 suppresses interfering waves of frequencies in the vicinity of the fundamental frequency of the local signal multiplied by any integer having at least either one of 2 and 3 as a submultiple.

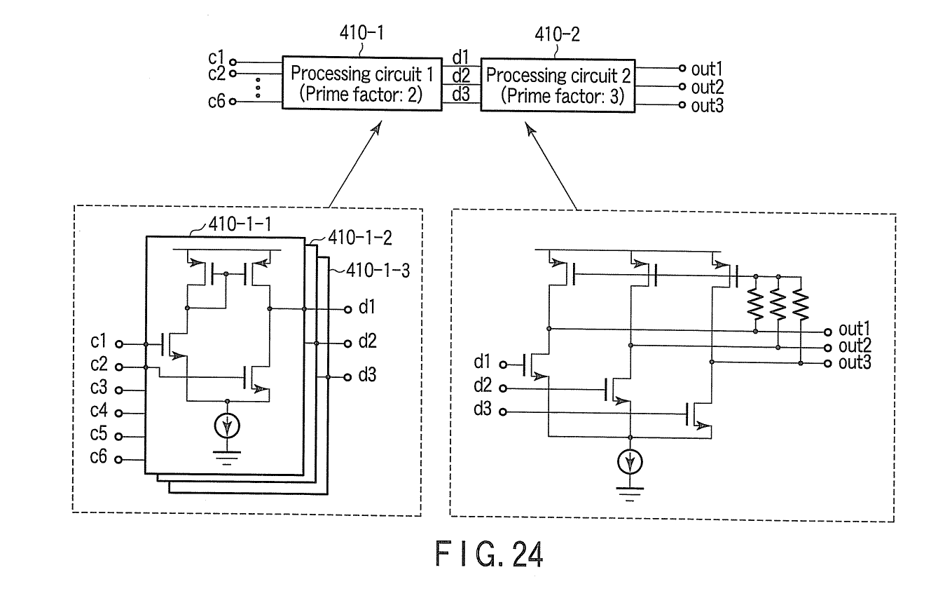

FIG. 24 shows an example structure of the processing circuits 410-1 and 410-2 of FIG. 23. The processing circuit 410-1 is three CMOS differential pairs in which the active load circuit is formed by a current mirror circuit. The processing circuit 410-1 suppresses the common mode of the two-phase signals, converts them to single-phase signals and outputs the signals. The processing circuit 410-2 is a three-phase operational amplifier that amplifies the three-phase signals received from the three CMOS differential pairs. The processing circuit 410-2 suppresses the common mode for the three-phase signals by detecting the common mode by use of the register on the output side and sending it to the current source load.

As discussed above, the frequency converting circuit according to the present embodiment multiplies the radio signal by multiphase local signals the number of which is the same as an integer n having the number m of different prime factors p1, . . . , pm so as to generate multiphase baseband signals. The common mode is thereby suppressed for the multiphase signal groups having the same number of signals as any one of the prime factors p1, . . . , pm. For this reason, the frequency converting circuit according to the present embodiment suppresses interfering waves of frequencies in the vicinity of the fundamental frequency of the local signal multiplied by any integer having at least one of the prime factors p1, . . . , pm as a submultiple.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A receiver comprising:
a multiphase mixer that multiplies a received radio signal by multiphase local signals the number of which is the same as an integer having a first prime factor and a second prime factor different from the first prime factor, and generates first multiphase baseband signals the number of which is the same as the integer;
a first processing circuit that suppresses common modes for first multiphase signal groups formed by dividing the first multiphase baseband signals into groups of signals the number of which is the same as the first prime factor, and generates second multiphase baseband signals; and
a second processing circuit that suppresses common modes for second multiphase signal groups formed by dividing the second multiphase baseband signals into groups of signals the number of which is the same as the second prime factor, and generates third multiphase baseband signals.

2. The receiver according to claim 1, wherein:
the first processing circuit includes a filter that is provided with a common mode feedback circuit and generates the second multiphase baseband signals by suppressing the common mode detected by the common mode feedback circuit for the first multiphase signal groups and also by limiting frequency bands of the first multiphase signal groups.

3. The receiver according to claim 1, wherein:
the second processing circuit includes a filter that is provided with a common mode feedback circuit and generates the third multiphase baseband signals by suppressing the common mode detected by the common mode feedback circuit for the second multiphase signal groups and also by limiting frequency bands of the second multiphase signal groups.

4. The receiver according to claim 1, wherein:
the first processing circuit includes:
a filter that is provided with a common mode feedback circuit, and generates fourth multiphase baseband signals by suppressing the common mode detected by the common mode feedback circuit for third multiphase signal groups formed by dividing multiphase combined signals into groups of signals the number of which is the same as the first prime factor, wherein the multiphase combined signals are generated by combining multiphase feedback signals that are generated from the second multiphase baseband signals supplied as feedback and the first multiphase baseband signals; and
a quantizer that quantizes the fourth multiphase baseband signals to generate the second multiphase baseband signals.

5. The receiver according to claim 1, wherein:
the second processing circuit includes:
a filter that is provided with a common mode feedback circuit, and generates fourth multiphase baseband signals by suppressing the common mode detected by the common mode feedback circuit for third multiphase signal groups formed by dividing multiphase combined signals into groups of signals the number of which is the same as the second prime factor, wherein the multiphase combined signals are generated by combining multiphase feedback signals that are generated from the third multiphase baseband signals supplied as feedback and the second multiphase baseband signals; and
a quantizer that quantizes the fourth multiphase baseband signals to generate the third multiphase baseband signal.

6. The receiver according to claim 1, wherein:
the first processing circuit includes a first filter that is provided with a first common mode feedback circuit, and generates the second multiphase baseband signals by suppressing the common mode detected by the first common mode feedback circuit for third multiphase signal groups formed by dividing first multiphase combined signals into groups of signals the number of which is the same as the first prime factor, wherein the first multiphase combined signals are generated by combining multiphase feedback signals that are generated from the third multiphase baseband signals supplied as feedback and the first multiphase baseband signals, and
the second processing circuit includes:
a second filter that is provided with a second common mode feedback circuit, and generates fourth multiphase baseband signals by suppressing the common mode detected by the second common mode feedback circuit for fourth multiphase signal groups formed by dividing second multiphase combined signals into groups of signals the number of which is the same as the second prime factor, wherein the second multiphase combined signals are generated by combining the multiphase feedback signals and the second multiphase baseband signals; and
a quantizer that quantizes the fourth multiphase baseband signals to generate the third multiphase baseband signals.

7. The receiver according to claim 1, wherein:
the first processing circuit includes a variable gain amplifier that is provided with a common mode feedback circuit, and generates the second multiphase baseband signals by suppressing the common mode detected by the common mode feedback circuit for the first multiphase signal groups and also by amplifying signal levels of the first multiphase signal groups.

8. The receiver according to claim 1, wherein:
the second processing circuit includes a variable gain amplifier that is provided with a common mode feedback circuit, and generates the third multiphase baseband signals by suppressing the common mode detected by the common mode feedback circuit for the second multiphase signal groups and also by amplifying signal levels of the second multiphase signal groups.

9. A frequency converting circuit comprising:
a multiphase mixer that multiplies a received radio signal by multiphase local signals the number of which is the same as an integer having a first prime factor and a second prime factor that is different from the first prime factor, and generates first multiphase baseband signals the number of which is the same as the integer;
a first processing circuit that suppresses common modes for first multiphase signal groups formed by dividing the first multiphase baseband signals into groups of signals the number of which is the same as the first prime factor, and generates second multiphase baseband signals; and
a second processing circuit that suppresses common modes for second multiphase signal groups formed by dividing the second multiphase baseband signals into groups of signals the number of which is the same as the second prime factor, and generates third multiphase baseband signals.
